(19) United States
(12) Patent Application Publication
(10) Pub. No.: US 2019/0303960 A1
(43) Pub. Date: Oct. 3, 2019

(54) SYSTEM AND METHOD FOR CRYPTOCURRENCY GENERATION AND DISTRIBUTION

(71) Applicant: MZ IP Holdings, LLC, Palo Alto, CA (US)

(72) Inventor: Matt Walsh, San Carlos, CA (US)

(21) Appl. No.: 16/359,171

(22) Filed: Mar. 20, 2019

Related U.S. Application Data
(60) Provisional application No. 62/650,404, filed on Mar. 30, 2018.

(51) Int. Cl. G06Q 30/02; G06Q 20/06; H04L 9/32

(52) U.S. Cl. CPC G06Q 30/0209; H04L 2209/38; H04L 9/3236; G06Q 20/065

(57) ABSTRACT

Implementations of the present disclosure are directed to a method, a system, and an article for mining cryptocurrency on client devices while the client devices are being used to participate in an online group activity. An example method includes: providing a multiplayer online game on a plurality of user client devices; mining a cryptocurrency on each client device while users of the client devices interact with the multiplayer online game; assigning at least a portion of the mined cryptocurrency to at least one of the users according to the user interactions with the multiplayer online game; and distributing the at least a portion of the mined cryptocurrency according to the assignment.

### CROSS-REFERENCE TO RELATED APPLICATIONS

This application claims the benefit of U.S. Provisional Patent Application No. 62/650,404, filed Mar. 30, 2018, the entire contents of which are incorporated by reference herein.

### BACKGROUND

The present disclosure relates to cryptocurrency generation and, in some examples, to systems and methods for activity-coupled, group blockchain-style cryptocurrency generation and distribution.

Cryptocurrencies such as BITCOIN, LITECOIN, and ETHEREUM (ETHER) have increased in popularity during the past several years. Cryptocurrencies are generally decentralized, not linked to any government, and permit direct transactions, while maintaining stability and trust associated with many government-issued currencies. BITCOIN currently has billions of dollars in total distribution.

Cryptocurrency transactions can be secured by data stored in a public ledger called a blockchain. The data can include a timestamp for each transaction and a digital hashtag to ensure blockchain integrity. The data can include details about the cryptocurrency and specific transaction information, such as payer and payee information. The blockchain can utilize a peer-to-peer or distributed approach, in which a network of nodes or computing devices record and validate the cryptocurrency transactions. For example, a group of computers can cooperatively and independently receive and review a set of cryptocurrency transactions. All computers in the pool can attempt to independently validate the transactions. When more than 50% of the computers in the group arrive at the same answer, the set of transactions can become official, and one of the computers can be randomly selected to receive a reward (e.g., a unit or coin of cryptocurrency). The production of cryptocurrency in exchange for validating cryptocurrency transactions can be referred to as “mining.”

To prevent fraud or tampering (e.g., through instantiation of large numbers of computers acting maliciously to create a majority vote), cryptocurrencies can employ a “proof of work” component in which each computer performs additional computations that are extraneous to the transaction being reviewed. Most of the high CPU cost associated with mining stems from this proof of work activity. The time to complete proof of work can be both considerable from a computer's point of view and also variable and unpredictable. Random numbers with trial-and-error can be employed, such that two equally equipped computers may complete the proof of work at different times.

### SUMMARY

In general, the systems and methods described herein allow cryptocurrency to be mined in the background on client devices while users of the client devices are participating in a group online activity, such as a multiplayer online game or portion thereof. In a typical example, the multiplayer online game is provided on a plurality of user client devices. A cryptocurrency is mined on each client device while users of the client devices interact with the multiplayer online game. The cryptocurrency mined by each client device can be combined to determine a total amount of mined cryptocurrency. At least a portion of the mined cryptocurrency can be assigned to one or more of the users according to the user interactions with the multiplayer online game. For example, a winner of a competition in the online game can receive most or all of the mined cryptocurrency. The mined cryptocurrency can be distributed to the users according to the assignment. Additionally or alternatively, the mined cryptocurrency can be distributed according to a user's contribution to the mining operations.

Advantageously, the approach described herein can incentivize users to participate in various online activities, such as multiplayer online games or online competitions. The opportunity to receive a cryptocurrency or other reward for participating in mining operations can encourage users to participate. This can improve overall engagement with the online activity.

Additionally, the approach described herein can take advantage of vast amounts of computing power associated with thousands or millions of client devices used to participate in online activities. Collectively, these client devices can work together to perform cryptocurrency operations (e.g., blockchain calculations or calculations associated with other suitable distributed ledger technologies) thousands or millions of times faster than a single device working alone. In one example, it may take a single client device 100,000 hours to mine a single unit of cryptocurrency (e.g., one BITCOIN coin). One million client devices working together, however, could mine the single unit of cryptocurrency in about 0.1 hours (6 minutes). It is common for certain online activities (e.g., massively multiplayer online games) to be accessed regularly by thousands or millions of client devices. Further, such client devices are rarely operating at full capacity during online activities. The systems and methods described herein are able to take advantage of computing power that may otherwise go to waste.

In one aspect, the subject matter described in this specification relates to a computer-implemented method. The method includes: providing a multiplayer online game on a plurality of user client devices; mining a cryptocurrency on each client device while users of the client devices interact with the multiplayer online game; assigning at least a portion of the mined cryptocurrency to at least one of the users according to the user interactions with the multiplayer online game; and distributing the at least a portion of the mined cryptocurrency according to the assignment.

In certain examples, mining the cryptocurrency can include performing blockchain operations on each client device. Performing the blockchain operations can include processing transactions associated with the cryptocurrency and/or performing proof of work operations. Each client device can be configured to use a first thread of execution for providing the multiplayer online game and a second thread of execution for mining the cryptocurrency. Each client device can include a first processor and a second processor, and each client device can be configured to use the first processor for providing the multiplayer online game and the second processor for mining the cryptocurrency. Each client device can include a first client application for providing the multiplayer online game and a second client application for mining the cryptocurrency.

In some implementations, each client device is configured to mine the cryptocurrency cooperatively or competitively with other client devices from the plurality of user client devices.

The cryptocurrency can be mined while at least two of the users engage in a competition against each other in the multiplayer online game, and the at least a portion of the mined cryptocurrency can be assigned according to an outcome of the competition. A winner of the competition can receive more of the mined cryptocurrency. Assigning the at least a portion of the mined cryptocurrency can include: determining a contribution to the mined cryptocurrency by at least one client device in the plurality of user client devices; and assigning the at least a portion of the mined cryptocurrency according to the determined contribution.

In another aspect, the subject matter described in this specification relates to a system. The system includes one or more computer processors programmed to perform operations that include: providing a multiplayer online game on a plurality of user client devices; mining a cryptocurrency on each client device while users of the client devices interact with the multiplayer online game; assigning at least a portion of the mined cryptocurrency to at least one of the users according to the user interactions with the multiplayer online game; and distributing the at least a portion of the mined cryptocurrency according to the assignment.

In certain instances, mining the cryptocurrency can include performing blockchain operations on each client device. Performing the blockchain operations can include processing transactions associated with the cryptocurrency and/or performing proof of work operations. Each client device can be configured to use a first thread of execution for providing the multiplayer online game and a second thread of execution for mining the cryptocurrency. Each client device can include a first processor and a second processor, and each client device can be configured to use the first processor for providing the multiplayer online game and the second processor for mining the cryptocurrency. Each client device can include a first client application for providing the multiplayer online game and a second client application for mining the cryptocurrency.

In some examples, each client device is configured to mine the cryptocurrency cooperatively or competitively with other client devices from the plurality of user client devices. The cryptocurrency can be mined while at least two of the users engage in a competition against each other in the multiplayer online game, and the at least a portion of the mined cryptocurrency can be assigned according to an outcome of the competition. A winner of the competition can receive more of the mined cryptocurrency. Assigning the at least a portion of the mined cryptocurrency can include: determining a contribution to the mined cryptocurrency by at least one client device in the plurality of user client devices; and assigning the at least a portion of the mined cryptocurrency according to the determined contribution.

In another aspect, the subject matter described in this specification relates to an article. The article includes a non-transitory computer-readable medium having instructions stored thereon that, when executed by one or more computer processors, cause the computer processors to perform operations that include: providing a multiplayer online game on a plurality of user client devices; mining a cryptocurrency on each client device while users of the client devices interact with the multiplayer online game; assigning at least a portion of the mined cryptocurrency to at least one of the users according to the user interactions with the multiplayer online game; and distributing the at least a portion of the mined cryptocurrency according to the assignment.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims.

### DESCRIPTION OF THE DRAWINGS

FIG. 1 is a schematic diagram of an example system for mining cryptocurrency on user client devices while users of the client devices participate in an online activity.

FIG. 2 is a schematic data flow diagram of an example method of mining cryptocurrency on user client devices while users of the client devices participate in an online activity.

FIG. 3 is a flowchart of an example method of mining cryptocurrency on user client devices while users of the client devices participate in an online activity.

### DETAILED DESCRIPTION

In general, the systems and methods described herein relate to the generation and distribution of blockchain-style cryptocurrency in a computer-based group activity (e.g., a multiplayer online game) by two or more users (also referred to herein as “players” or “participants”). In a typical example, users can interact with one another in an online activity (e.g., the multiplayer online game) while the users' client devices are performing background operations to mine cryptocurrency. The online activity can involve or include, for example, user competitions, user teamwork or collaborations, and/or user communications (e.g., text chat messaging). The cryptocurrency mining operations can be performed on each client device in a thread of execution that is separate from a thread of execution used to provide the online activity. Additionally or alternatively, the background operations can be performed on each client device using a processor that is separate from a processor used to provide the online activity.

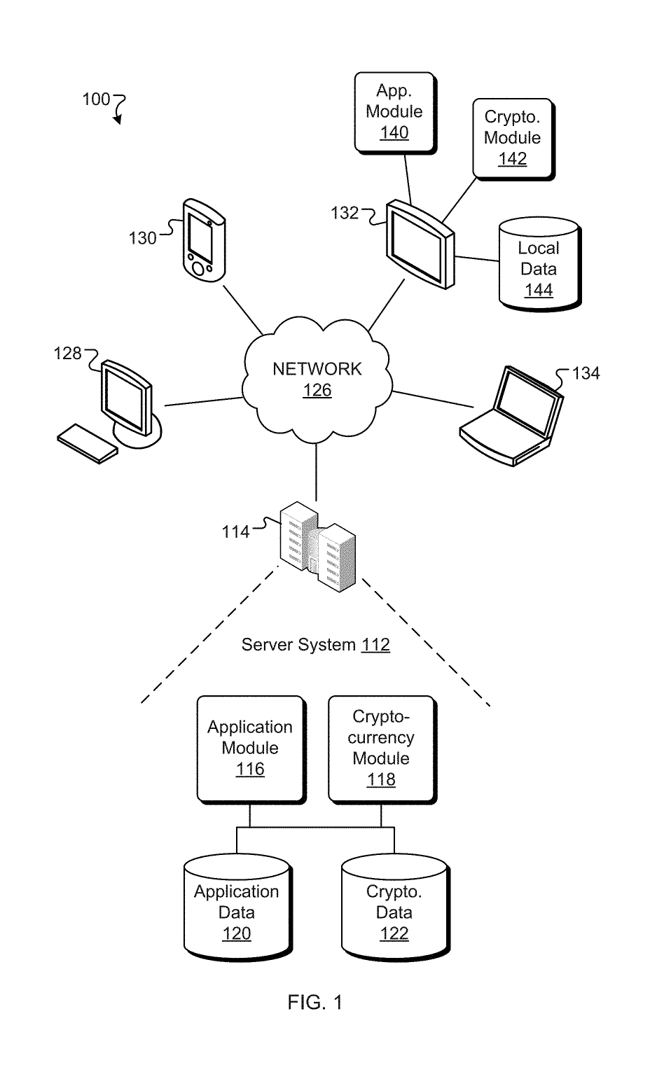

FIG. 1 illustrates an example system 100 for mining cryptocurrency on user client devices while the users of the client devices interact with one another in a computer-based group activity. A server system 112 provides functionality for providing the online activity and mining and distributing the cryptocurrency. The server system 112 includes software components and databases that can be deployed at one or more data centers 114 in one or more geographical locations, for example. The server system 112 software components can include an application module 116 and a cryptocurrency module 118. The software components can include subcomponents that can execute on the same or on different individual data processing apparatus. The server system 112 databases can include an application data 120 database and a cryptocurrency data 122 database. The databases can reside in one or more physical storage systems. The software components and data will be further described below. In various examples, the online activity can be hosted by a host entity (e.g., a company) and the various databases and software components described herein can be provided by the host entity.

A software application, such as, for example, a client-based and/or web-based software application, can be provided as an end-user application to allow users to interact with the server system 112. The software application can relate to and/or provide a wide variety of functions and information, including, for example, entertainment (e.g., a game, music, videos, etc.), business (e.g., word processing, accounting, spreadsheets, etc.), news, weather, finance, sports, etc. In preferred implementations, the software application provides a computer game, such as a multiplayer online game. The software application or components thereof can be accessed through a network 126 (e.g., the Internet) by users of client devices, such as a personal computer 128, a smart phone 130 (or similar mobile device), a tablet computer 132, and a laptop computer 134. Other client devices are possible. In alternative examples, the application data 120 and/or the cryptocurrency data 122 or any portions thereof can be stored on one or more client devices. Additionally or alternatively, software components for the system 100 (e.g., the application module 116 and/or the cryptocurrency module 118) or any portions thereof can reside on or be used to perform operations on one or more client devices.

Each client device in the system 100 can utilize or include software components and/or databases for the software application. The software components on the client devices can include an application module 140 and a cryptocurrency module 142. The application module 140 can be or include a client application that provides the software application on the client devices. The cryptocurrency module 142 can be or include a client application that is used to mine cryptocurrency on the client devices. In alternative examples, the application module 140 and the cryptocurrency module 142 can be integrated into a single software component. For example, the cryptocurrency module 142 or portions thereof can be included as part of the application module 140. The databases on the client devices can include a local data 144 database, which can store data for the software application and/or cryptocurrency operations and exchange the data with the application module 140, the cryptocurrency module 142, and/or with other software components for the system 100, such as the application module 116 and/or the cryptocurrency module 118. The data stored on the local data 144 database can include, for example, user history data, cryptocurrency transaction or mining data, user preferences, image data, video data, audio data, and/or any other data used or generated by the system 100. While the application module 140, the cryptocurrency module 142, and the local data 144 database are depicted as being associated with the tablet computer 132, it is understood that other client devices (e.g., the personal computer 128, the smart phone 130, and/or the laptop computer 134) can include the application module 140, the cryptocurrency module 142, the local data 144 database, or any portions thereof.

FIG. 1 depicts the application module 116 and the cryptocurrency module 118 as being able to communicate with the application data 120 database and the cryptocurrency data 122 database. The application data 120 database generally includes information related to the software application (e.g., a multiplayer online game) implemented using the system 100. The application data 120 database can include, for example, information related to a virtual environment, image, video and/or audio data, user data, event data corresponding to previous, current or future events, and/or application state data (e.g., defining a current state of an online game). The cryptocurrency data 122 database generally includes data related to cryptocurrency operations performed on the client devices. Such information can be or include, for example, information related to cryptocurrency transactions, cryptocurrency accounts (e.g., for one or more users), cryptocurrency contributions by the client devices, cryptocurrency values, cryptocurrency allocations to users, and/or other cryptocurrency data or information.

In various examples, the software application can provide an online game that can be played by hundreds of thousands or even millions of users. The users can have certain user capabilities in a virtual environment for the online game. The user capabilities can be or include, for example, moving an avatar or a virtual item or object to a different geographical or spatial location, interacting with characters or other users, participating in user groups or alliances, competing against other users, attacking other users, deploying troops, defending against an attack from other users, deploying defenses, building or modifying a virtual item or object (e.g., a virtual building or other structure), developing a new skill, operating a vehicle, acquiring a virtual item (e.g., a weapon), using or interacting with a virtual item (e.g., a playing card or a weapon), and performing supernatural tasks (e.g., casting a spell). Other user capabilities are possible. The virtual environment for the online game can be rendered for users in the form of, for example, graphics, images, video, audio, text, and/or haptic feedback. In an adventure game, for example, a graphical user interface can display a virtual environment that includes representations of characters (e.g., people or animals), natural features (e.g., mountains, rivers, fields, trees, and/or weather conditions), and/or man-made features (e.g., buildings, bridges, and/or vehicles).

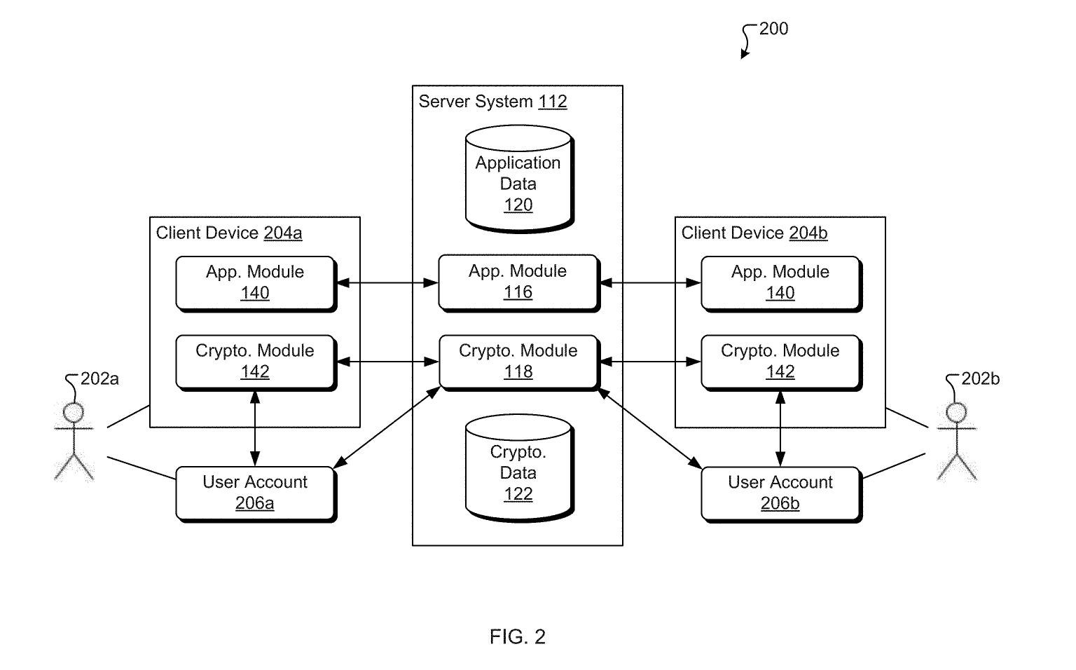

FIG. 2 is a schematic data flow diagram of a method 200 in which the application module 116 and the cryptocurrency module 118 are used to provide an online group activity while cryptocurrency is mined on user client devices. In the depicted example, a first user 202a and a second user 202b utilize a first client device 204a and a second client device 204b, respectively, to interact with one another in the online group activity. The application module 116 on the server system 112 can provide the online activity by coordinating with the application module 140 on each of the client devices 204a and 204b. At the same time, the cryptocurrency module 118 can coordinate with the cryptocurrency module 142 on each of the client devices 204a and 204b, to perform cryptocurrency operations. While FIG. 2 depicts two users 202a and 202b and two client devices 204a and 204b, it is understood that the online group activity can be provided to more than two users and that cryptocurrency operations can be performed on more than two client devices.

In a typical example, the two users 202a and 202b can be participants in a multiplayer online game (e.g., a player vs. player mobile game). The users 202a and 202b can be brought together in a match or competition in the online game, for example, using a matchmaking process, which can be based on compatibility (e.g., two players of similar skill, as measured by an Elo rating system). Additionally or alternatively, the users 202a and 202b can voluntarily choose each other for the competition and/or can form one or more user groups that can compete with one another. The competition can be or include, for example, a virtual fight, a virtual battle, a virtual race, and/or a virtual sport (e.g., football or tennis). When the online game or competition is initiated, the users 202a and 202b can begin to compete or otherwise interact with one another using the client devices 204a and 204b, respectively. For example, the online game and the competition can be provided on the client devices 204a and 204b using the application module 140 and the application module 116. At the same time, cryptocurrency mining operations can be initiated (or resumed or maintained) on each of the client devices 204a and 204b, for example, using the cryptocurrency module 142 and the cryptocurrency module 118. The cryptocurrency mining operations can be performed to mine BITCOIN or other suitable cryptocurrencies (e.g., a cryptocurrency specifically created for the online group activity) on the client devices 204a and 204b.

The cryptocurrency operations on the client devices 204a and 204b can be organized or performed in various ways. For example, both client devices 204a and 204b can perform cryptocurrency operations competitively or cooperatively. In a competitive arrangement, the two client devices 204a and 204b can each attempt to be the first to perform one or more calculations or sequences of calculations. The calculations can relate to, for example, reviewing cryptocurrency transactions and/or performing proof of work, although the calculations can perform other suitable consensus-based processing techniques used to validate cryptocurrency transactions. The client device that is first to perform the calculations can receive (or be credited with receiving) one or more units of the cryptocurrency (e.g., one BITCOIN). In a cooperative or collaborative arrangement, the two client devices 204a and 204b can share a workload or work together as a team to perform the cryptocurrency calculations (e.g., in a divide-and-conquer or parallel processing arrangement). Cooperative completion of the calculations can result in both client devices receiving (or being credited with receiving) one or more units of the cryptocurrency or portions thereof. In the competitive or cooperative arrangement, the two client devices 204a and 204b can perform cryptocurrency operations with one or more other nodes or computing devices (e.g., operated by different users). The computing devices can work together to validate and record cryptocurrency transactions and/or verify any modifications to the record of transactions. Alternatively or additionally, the two client devices 204a and 204b can be functioning in different groups of nodes or computing devices, for example, with the two client devices 204a and 204b working on altogether different cryptocurrencies or cryptocurrency transactions. Other arrangements for performing the cryptocurrency operations are possible.

At a conclusion of the competition between the two users 202a and 202b, the server system 112 (e.g., using the cryptocurrency module 118) can combine all mined cryptocurrency units (or portions thereof) from the two client devices 204a and 204b (and any other participating client devices) to provide a full accounting of the cryptocurrency generated during the competition, in preparation for distribution. The combined cryptocurrency can be distributed among the participants and, in some instances, a portion of the cryptocurrency can be distributed to the host. Distribution patterns can mirror a type of relationship formed between players during the competition. For example, in a 1-on-1 competitive game, a winner take all distribution can result in most or all of the generated cryptocurrency being assigned to the winner. In a doubles or 2-on-2 scenario, a winning pair of players can receive most or all of the combined cryptocurrency generated by a pool of four players. Alternatively or additionally, players of competitive games can chose friendly versions of 1-on-1 and 2-on-2 matches, in which the generated cryptocurrency can be divided (e.g., equally) between all participants. In any of these examples, players who performed better during the competition can receive a larger portion of the mined cryptocurrency. Some or all of the generated cryptocurrency can be distributed to the host. This can allow the host to receive at least some compensation for providing the online activity.

In a specific example, the application module 116 provides a multiplayer mobile strategy game for the two users 202a and 202b. During a match between the two users 202a and 202b, the client device 204a belonging to user 202a may perform cryptocurrency work sufficient to mine three units of cryptocurrency, while the client device 204b belonging to user 202b may perform cryptocurrency work sufficient to mine two units, for a combined total of five mined cryptocurrency units. If the user 202a wins the match, the cryptocurrency module 118 may award 4.5 cryptocurrency units (90% of the combined total) to user 202a and may award 0.5 cryptocurrency units (10% of the combined total) to the host. User 204b may receive no cryptocurrency units in this example. Other methods or allocations for distributing the cryptocurrency units are possible. For example, the user who loses the match can receive at least a portion of the mined cryptocurrency. Additionally or alternatively, the cryptocurrency can be distributed to each user according to the user's contribution (or the respective client device's contribution) to the mining operations. Users who have better or faster client devices may be entitled to larger cryptocurrency distributions in such instances. In some examples, a unit of cryptocurrency can be a smallest transferable item of the cryptocurrency, such as a single coin.

In various implementations, the users 202a and 202b can be associated with and/or can have access to cryptocurrency accounts 206a and 206b, respectively, which can be used to receive and/or store cryptocurrency for the users 202a and 202b. For example, when cryptocurrency from the online activity is distributed to user 202a, the cryptocurrency module 118 can credit the user's cryptocurrency account 206a accordingly. In preferred examples, the cryptocurrency module 142 can provide a wallet feature that allows the users 202a and 202b to manage their respective cryptocurrency accounts 206a and 206b. The wallet feature can allow the users 202a and 202b to check account balances and make cryptocurrency transfers to or from the accounts. For example, the users 202a and 202b can use the wallet feature to redeem earned cryptocurrency units.

Cryptocurrency mining can be performed on client devices at various times. In some instances, for example, cryptocurrency mining can be performed only while two or more user client devices are involved in a discrete competition or match. When the match is completed and the client devices' mining operations are terminated, other computing devices can pick up where the client devices left off. For example, the mining operations can be continued by a server (e.g., the server system 112) and/or by one or more other client devices that have initiated a separate competition or match. In some examples, when a client device begins a new match, the client device can resume mining operations from a previous match. Alternatively or additionally, cryptocurrency mining can be performed any time a user is logged in to an online activity, regardless of whether or not the user is participating in a competition with other users. In further examples, cryptocurrency mining can be performed on a client device even after the user logs out of the online activity (e.g., by closing the application module 116). Any mining progress made by the client device during offline activity can be reported to the cryptocurrency module 118 when the client device logs back in to the online activity. This can allow the client device to receive credit for the offline mining operations.

To coordinate mining operations among multiple devices, the cryptocurrency calculations can be divided into subsets, with each device taking a subset or portion thereof. Additionally, blockchain operations (or operations associated with other suitable distributed ledger technologies) can be performed in parallel. There can be little need for one processor to know what other processors are doing, such that each device can work on its own with little or no coordination with other devices. This allows the mining operations described herein to be performed simultaneously by hundreds or thousands or millions of client devices.

In certain examples, cryptocurrency mining can require significant computing power and/or may not permit the generation of partial cryptocurrency units (e.g., half a BITCOIN). It can take months or years, for example, for a single smartphone or PC to perform the calculations necessary to mine a single BITCOIN unit or coin. Such computation times may not be suitable for the systems and methods described herein, given that the online activities for cryptocurrency mining can be much shorter in duration (e.g., 30 minutes, 10 minutes, 3 minutes, or less). Accordingly, to make it easier for client devices to generate cryptocurrency, it can be preferable to use a cryptocurrency that can be mined with less computing power and/or over short time periods. In one example, a cryptocurrency can be used that is capable of being mined by a standard smartphone or other mobile device in about one minute, about three minutes, or about 10 minutes. This can make it feasible for standard mobile phones or similar client devices to generate at least one cryptocurrency unit during the online activity. While the value of a coin or unit of such a cryptocurrency may be much lower (e.g., thousands or millions of times lower) than the value of other cryptocurrencies (e.g., BITCOIN), the lower value may still provide a sufficient incentive for users to participate in the online activity and the mining operations. In preferred implementations, the cryptocurrency distributed to users can be exchanged for other cryptocurrencies or government-issued currencies.

Additionally or alternatively, conventional cryptocurrencies such as BITCOIN can be mined by the client devices, as described herein, and users who participate in the creation of a cryptocurrency unit can receive less than full value of the cryptocurrency unit. For example, each time a user joins an online activity and performs cryptocurrency operations, the user's client device can contribute to a portion of the total effort required to generate one cryptocurrency unit. As compensation, the user can receive a reward based on the user's mining contribution. For example, if a cryptocurrency unit has a value of $10,000 and requires 10,000 hours to generate, a user who contributes one hour (60 minutes) to the generation of a single unit can be rewarded with $1 (i.e., $1=$10,000*1 hour/10,000 hours). While no single client device may generate an entire cryptocurrency unit on its own, the user of a contributing client device can be rewarded for the client device's share of the mining effort.

In various implementations, each client device can use parallel processing to participate in the online activity and mine cryptocurrency at the same time. In some instances, for example, cryptocurrency mining operations can be performed on a client device in a thread of execution that is separate from a thread of execution used to provide the online activity. Additionally or alternatively, a client device can have multiple processors (e.g., coprocessors, graphics processors, image processors, etc.), and a first processor can be used to participate in the online activity while a second processor can be used to mine the cryptocurrency. An operating system on the client device can assign the online activity to the first processor and the cryptocurrency mining to the second processor.

In some examples, the cryptocurrency described herein can relate specifically to the online activity, such that units of the cryptocurrency can be redeemable or usable in the online activity. A unit of the cryptocurrency can be or include, for example, one or more virtual items for a virtual environment in an online game. Such virtual items can include, for example, a virtual currency (e.g., virtual gold or gems), virtual clothing, virtual skin, virtual suits, virtual armor, virtual weapons, virtual defenses, virtual playing cards, virtual tools, virtual machines (e.g., vehicles), or any other virtual item that can be of value to users who engage in the online activity. Such virtual items can preferably be fully transferable by users inside or outside of the game environment or other online activity. Advantageously, the cryptocurrency calculations (e.g., blockchain processing or processing associated with other suitable distributed ledger technologies) performed by user client devices can allow users to determine how many of each virtual item is in existence. Knowing the available supply of an item can allow users to make better decisions regarding the value of the item.

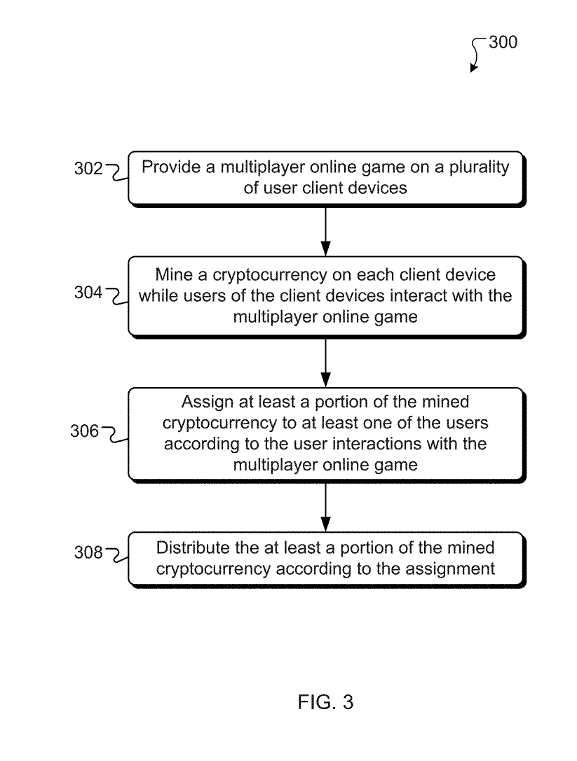

FIG. 3 illustrates an example computer-implemented method of mining cryptocurrency on client devices while users of the client devices participate in an online group activity (e.g., a multiplayer online game). A multiplayer online game is provided (step 302) on a plurality of user client devices. A cryptocurrency is mined (step 304) on each client device while users of the client devices interact with the multiplayer online game. At least a portion of the mined cryptocurrency is assigned (step 306) to at least one of the users according to the user interactions with the multiplayer online game. The at least a portion of the mined cryptocurrency is distributed (step 308) according to the assignment.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method, comprising:
providing a multiplayer online game on a plurality of user client devices;
mining a cryptocurrency on each client device while users of the client devices interact with the multiplayer online game;
assigning at least a portion of the mined cryptocurrency to at least one of the users according to the user interactions with the multiplayer online game; and
distributing the at least a portion of the mined cryptocurrency according to the assignment.

2. The method of claim 1, wherein mining the cryptocurrency comprises:
performing blockchain operations on each client device.

3. The method of claim 2, wherein performing the blockchain operations comprises at least one of:
processing transactions associated with the cryptocurrency; or performing proof of work operations.

4. The method of claim 1, wherein each client device is configured to use a first thread of execution for providing the multiplayer online game and a second thread of execution for mining the cryptocurrency.

5. The method of claim 1, wherein each client device comprises a first processor and a second processor, and wherein each client device is configured to use the first processor for providing the multiplayer online game and the second processor for mining the cryptocurrency.

6. The method of claim 1, wherein each client device comprises a first client application for providing the multiplayer online game and a second client application for mining the cryptocurrency.

7. The method of claim 1, wherein each client device is configured to mine the cryptocurrency cooperatively or competitively with other client devices from the plurality of user client devices.

8. The method of claim 1, wherein the cryptocurrency is mined while at least two of the users engage in a competition against each other in the multiplayer online game, and wherein the at least a portion of the mined cryptocurrency is assigned according to an outcome of the competition.

9. The method of claim 8, wherein a winner of the competition receives more of the mined cryptocurrency.

10. The method of claim 1, wherein assigning the at least a portion of the mined cryptocurrency comprises:
determining a contribution to the mined cryptocurrency by at least one client device in the plurality of user client devices; and
assigning the at least a portion of the mined cryptocurrency according to the determined contribution.

11. A system comprising:
one or more computer processors programmed to perform operations comprising:
providing a multiplayer online game on a plurality of user client devices;
mining a cryptocurrency on each client device while users of the client devices interact with the multiplayer online game;
assigning at least a portion of the mined cryptocurrency to at least one of the users according to the user interactions with the multiplayer online game; and
distributing the at least a portion of the mined cryptocurrency according to the assignment.

12. The system of claim 11, wherein mining the cryptocurrency comprises:
performing blockchain operations on each client device.

13. The system of claim 12, wherein performing the blockchain operations comprises at least one of:
processing transactions associated with the cryptocurrency; or
performing proof of work operations.

14. The system of claim 11, wherein each client device is configured to use a first thread of execution for providing the multiplayer online game and a second thread of execution for mining the cryptocurrency.

15. The system of claim 11, wherein each client device comprises a first processor and a second processor, and wherein each client device is configured to use the first processor for providing the multiplayer online game and the second processor for mining the cryptocurrency.

16. The system of claim 11, wherein each client device comprises a first client application for providing the multiplayer online game and a second client application for mining the cryptocurrency.

17. The system of claim 11, wherein each client device is configured to mine the cryptocurrency cooperatively or competitively with other client devices from the plurality of user client devices.

18. The system of claim 11, wherein the cryptocurrency is mined while at least two of the users engage in a competition against each other in the multiplayer online game, and wherein the at least a portion of the mined cryptocurrency is assigned according to an outcome of the competition.

19. The system of claim 11, wherein assigning the at least a portion of the mined cryptocurrency comprises:
determining a contribution to the mined cryptocurrency by at least one client device in the plurality of user client devices; and
assigning the at least a portion of the mined cryptocurrency according to the determined contribution.

20. An article, comprising:
a non-transitory computer-readable medium having instructions stored thereon that, when executed by one or more computer processors, cause the computer processors to perform operations comprising:
providing a multiplayer online game on a plurality of user client devices;
mining a cryptocurrency on each client device while users of the client devices interact with the multiplayer online game;
assigning at least a portion of the mined cryptocurrency to at least one of the users according to the user interactions with the multiplayer online game; and
distributing the at least a portion of the mined cryptocurrency according to the assignment.
